(19) United States
(12) Patent Application Publication
(10) Pub. No.: US 2006/0060298 A1
(43) Pub. Date: Mar. 23, 2006

(54) Selective body moulding removal solutions

(76) Inventors: Mark John Russell, Midway Point (AU); Ernest Duncan Bushell, Cardwell (AU)

Correspondence Address: MOORE & VAN ALLEN PLLC, P.O. BOX 13706, Research Triangle Park, NC, 27709, US

(21) Appl. No.: 10/946,594

(22) Filed: Sep. 21, 2004

(51) Int. Cl. C11D 3/20; B29C 63/00

(52) U.S. Cl. 156/344; 510/109

(57) ABSTRACT

A solution for use in removing adhesive tape from a body moulding of a motor vehicle, boat, caravan or like conveyance and/or rejuvenating said body moulding, said solution comprising: 1-99% by weight of a terpene (as herein defined); and 1-99% by weight of a diluent for said terpene.

The invention concerns the formulation of selective solvent blends useful in the repair of motor vehicles, boats, caravans and like conveyances which have body mouldings.

Body mouldings are strips of rubber, metallic or painted embellishments which are fitted to the exterior surfaces of the conveyance and which often have the added function of providing a degree of protection from damage which would otherwise occur from bumping or similar light contact against the exterior surface. Such body mouldings are generally fitted with a double-sided adhesive tape. The adhesive used is of sufficient gripping power to prevent easy removal of the moulding from the conveyance, but which provides maximum adherence between the moulding and the tape itself, to thus enable the moulding to be peeled from the conveyance while the tape remains adhered to the moulding.

In the repair of conveyances such as motor vehicles, the body moulding is generally the first item to be removed from the damaged panel. The moulding is often suitable for re-use once the panel has been fixed and refitted. However, before the moulding can be re-used, the double-sided adhesive tape must be removed. This is usually a time consuming and expensive operation. There are basically four ways of doing this, viz by grinding, hot blowing, using a razor blade or a thumb, or using a solvent.

Grinding with a grinding wheel can frequently damage the moulding or leave a bad surface on the moulding which means that the moulding cannot be properly re-fitted and is subject to falling off. Grinding is, furthermore, a messy and polluting operation and requires the use of a solvent to clean the area which has been ground. Solvents are not only a safety hazard due to fire and fumes, but can only be used on non-painted mouldings. Overall, grinding is a time consuming and expensive operation.

Hot blowers are machines used to heat the adhesive strip to soften the adhesive and thereby permit the strip to be pulled from the moulding. Such blowers are expensive and frequently damage the moulding. Hot blowers are not in wide use.

Scraping with a razor blade or thumb has the disadvantage that the operator can end up with blisters or cut fingers. It is also a time consuming process and therefore expensive.

The use of solvents per se is often resorted to in order to prevent any damage to the moulds occurring. Additionally, mouldings can be left to soak unattended before easy removal, reducing labour time and costs.

The current solvent-based mould-removal industry is characterised by many of the disadvantages of using solvents. Large quantities have to be applied to be effective, which results in wastage, as a good portion cannot be re-used, and they are often a high fire risk. Poor selectivity and solvating power means that operator involvement is necessary, it is a messy operation requiring a large work area, and operators get their hands covered in glue and solvent. Furthermore, as mentioned above, current solvent blends are limited in their use to non-painted mouldings since they tend to damage paint.

In our earlier US patent, U.S. Pat. Nos. 5,376,299 and 5,780,408, we disclosed a solution for use in removing double-sided adhesive tape from mouldings used on motor vehicles and the like characterised in that it contained a refined petroleum product such as kerosene as the base, oil of turpentine and an oil-based surface active agent as well as optional additives selected from deodorizing agents, perfumes, colourants and inert liquid extenders. While satisfactory for the double-sided adhesive tapes available at that time, which in general were NEOPRENE rubber with a suitable adhesive applied thereto, the solution disclosed therein has not been suitable for removing the new generation of double-sided tapes manufactured from acrylic foam. Typical of these is the new 3M VHB double-sided tape. It was also found that the solution disclosed in the abovementioned US patents under normal workshop conditions could cause swelling of hollow cavity body mouldings and cause damage to the paintwork on painted body mouldings. Moreover, the solutions disclosed therein are volatile and both oil of turpentine and kerosene have a low flash point, hence these solutions represent a hazard when used in the workplace.

It was therefore desirable to provide a new manner of removing the double-sided adhesive tape from motor vehicle and like mouldings, which obviated or at least minimised the aforementioned disadvantages. The invention described in Australian Patent No. 734993 achieved this through the provision of a solution for use in removing the double-sided adhesive tape from mouldings and which, at least in preferred forms, had the further property of conditioning the moulding for re-use. The solution comprised an admixture of ingredients which synergistically function to give the desired properties and advantages, based around petroleum-derived aromatic hydrocarbon solvents blended with aliphatic hydrocarbons and with a small component of eucalyptus or tea tree oils to provide a masking odour for the kerosene base and extend the effect of the aromatic solvent base.

The aforedescribed inventions in their preferred embodiments, whilst satisfying many of the key operational criteria, nevertheless had several environmental limitations, notably reliance on non-renewable feedstocks, a powerful aromatic solvent odour and some concerns with skin contact and long term breathability safety issues.

Further investigations in our laboratory revealed that another class of solvents were well suited as major components in formulations designed to achieve our ultimate objective of providing effective, selective, safe, low odour, renewable body moulding removal solvents.

Terpenes and their derivatives are obtained from renewable plant and plantation tree resources and have become articles of commerce as solvents and carriers, and are claimed to have positive effects on health in some cases. As solvents, they possess many of the good solvating powers of petroleum-derived aromatic solvents, generally have a distinctive but pleasant odour, and have not been classified as hazardous.

Our investigations have shown that terpene solvents can wholly or partially replace aromatic solvents in body moulding removal formulations.

According to a first aspect of the present invention there is provided a method of removing adhesive tape from a body moulding of a motor vehicle, boat, caravan or like conveyance, said method comprising the steps of:

1) applying a terpene to said body moulding;

2) maintaining contact between the terpene and said body moulding for a predetermined time; and

3) removing said adhesive tape from said body moulding.

According to a second aspect of the present invention there is provided a method of repairing a motor vehicle, boat, caravan or like conveyance, said method comprising the steps of:

1) removing, an intact body moulding from a damaged portion of said motor vehicle, boat, caravan or like conveyance, said body moulding having been previously secured thereto with adhesive tape;

2) applying a terpene to said body moulding and maintaining contact for a predetermined time;

3) removing said adhesive tape from said body moulding; and

4) replacing said body moulding upon the now-repaired motor vehicle, boat, caravan or like conveyance.

According to a third aspect of the present invention there is provided an adhesive tape-free body moulding of a motor vehicle, boat, caravan or like conveyance when adhesive tape has been removed from said body moulding through contact with a terpene.

According to a fourth aspect of the present invention there is provided a method of rejuvenating a body moulding of a motor vehicle, boat, caravan or like conveyance, said method comprising the steps of:

1) applying a terpene to a body moulding;

2) maintaining contact between the terpene and said body moulding for a predetermined time.

According to a fifth aspect of the present invention there is provided a body moulding from a motor vehicle, boat, caravan or like conveyance when rejuvenated through contact with a terpene.

According to a sixth aspect of the present invention there is provided a motor vehicle when repaired by a method according to the second aspect of the invention.

According to a seventh aspect of the present invention there is provided a motor vehicle with rejuvenated body mouldings when said body mouldings are rejuvenated by a process according to the fourth aspect of the invention.

The term “terpene” as used throughout the description and claims refers to isolated terpenes as well as oils containing such compounds as their primary constituent, but excludes compositions comprising 2-40% by weight of tea tree oil and/or eucalyptus oil and 50-98% by weight of a hydrocarbon base including 10-60% by weight of aromatic hydrocarbons and which has a flash point above 50° C. The terpenes are hydrocarbons made up of one or more isoprene units or similar 5-carbon units which may be substituted by oxygen atoms, and include alicyclic and open chain structures. A monoterpene is made up of two isoprene units, a sesquiterpene is made of 3 units and a diterpene is made of 4 units. Some examples are D-limonene, natural pine terpentine, geraniol, tea tree oil, eucalyptus oil and citrus oil.

Preferred terpene solvents are D-limonene and oil of eucalyptus and tea tree oil.

D-Limonene is a clear water-white to slightly yellow liquid with a mild to strong citrus aroma depending on grade. It has a boiling point of 154° C. and a flash point of 46° C. It is registered under CAS Number 68647-72-3 (orange terpenes).

Tea tree oil is a clear water white to yellow liquid with a pleasant spicy odour. It has a flash point of 57-60° C. It is registered under CAS Number 68647-73-4.

Oil of eucalyptus is a light yellow to colourless liquid with a strong eucalyptus odour. It is slowly volatile at 100° C., but completely volatile at higher temperatures. It has a flash point of 43° C. It is registered under CAS Number 80000-48-4.

Unfortunately, at this stage of evolution of the plant-derived hydrocarbon solvent business, unit costs cannot compete favourably with high volume solvents derived from non-renewable petroleum feedstocks. Accordingly, the active solvent in the current invention is diluted for use to reduce viscosity and cost with a diluent or diluent blend made up of a primary diluent base and a secondary diluent.

According to a eighth aspect of the present invention there is provided a solution for use in removing adhesive tape from a body moulding of a motor vehicle, boat, caravan or like conveyance and/or rejuvenating said body moulding, said solution comprising:

1-99% by weight of a terpene; and

1-99% by weight of a diluent for said terpene.

According to a ninth aspect of the present invention there is provided a method of preparing a solution for use in removing adhesive tape from a body moulding of a motor vehicle, boat, caravan or like conveyance and/or rejuvenating said body moulding, said method comprising the steps of:

1) providing a terpene and a diluent for said terpene; and

2) mixing 1-99% by weight of said terpene and 1-99% by weight of said diluent.

The diluent typically comprises a primary diluent base which can be any suitable hydrocarbon feedstock including a saturated feedstock or a mixture of paraffins and naphthenes. Preferably, the diluent base is kerosene, preferably a high flash point kerosene to reduce the flammability of the formulation.

The action of the terpene solvent can be modified or extended by the inclusion of a secondary diluent. Typically 1-60% by weight of aromatic hydrocarbons is added to the primary diluent saturated hydrocarbon base stock. Suitable aromatic hydrocarbons include, but are not limited to, alkylated benzenes with an average carbon number of C9-C10, which provide diluents with suitable flash points, cost and solvent extending properties.

Advantageously the diluent is a mixture of a primary diluent comprising a mixture of paraffins and naphthenes (preferably 50-80%) and C9-C10 alkyl benzenes (preferably 20-50%).

Other suitable diluents for said primary hydrocarbon base include glycols such as hexylene glycol, propylene glycol and ethylene glycol.

Particularly preferred is hexylene glycol, which is typically present in an amount of 2-8% by weight.

Advantageously, the solution comprises 10-50% D-Limonene, tea tree oil or oil of eucalyptus.

Other optional additives include one or more surface active agents and perfumes or odorants.

Typically contact is maintained by immersing the body moulding in the solvent.

Mouldings which can be treated with the immediately preceding mixture include modified polypropylene, soft and flexible polyurethane, polyamine, acrylonitrile-butadiene-styrene, polycarbonate, polyphenylene-oxide, polymer, and polybutylene-terephthalate-polymer mouldings. Most importantly, new generation mouldings, which were found to be damaged by blends described in previous inventions, were able to be successfully treated with the new formulations: thermoplastic olefins (elastomers); thermoplastic rubber-modified; high-density polyethylene.

In a typical use, the body moulding with the double-sided adhesive tape is immersed in a container of the solution and let stand for at least three hours, preferably 6 to 20 hours, more preferably 8 to 12 hours. The body moulding is then removed from the solution and the double-sided tape is peeled off by hand on one action. The moulding is then dried with a rag and a new double-sided adhesive tape is applied prior to refixing the moulding to the vehicle.

The solution is reusable, wastage is negligible, the moulding is reconditioned and the moulding remains undamaged. There is also a lower fire risk than with conventional solvents or those disclosed in U.S. Pat. Nos. 5,376,299 and 5,780,408, and minimal time is involved by the operator as he can be attending to other matters while the solution is working.

The surface-active agent, where used, is selected to reduce the interfacial tension between the refined petroleum product and the terpene solvent, while promoting a sheen on the product to which it is applied. To this end, products such as vegetable oils having similar properties to linseed and castor oils, are preferred. The most preferred surfactant is castor oil itself.

Preferred embodiments of the present invention will be described, by way of example only, in the following examples.

Body mouldings were chosen from a range of imported cars, including those manufactured by Ford, Hyundai, Honda, Mazda, Jeep and Mustang.

### COMPARATIVE EXAMPLE 1

A solution was prepared by blending the following ingredients together in a container in the stated quantities:
90% by weight of mineral turpentine, flash point 38° C., 49% aromatics;
5% by weight of kerosene distillate, flash point 38° C.;
5% by weight of Nappar 10 (Exxon Mobil), flash point 43° C., 0.5% aromatics.

This test also proved to be unsatisfactory, after only 4 h soaking time, due to stretching of the moulding.

### COMPARATIVE EXAMPLE 2

A solution was prepared by blending the following ingredients together in a container in the stated quantities:
100% by weight of Shellsol A 150, flash point 63° C., 99% aromatics;

This test also proved to be unsatisfactory, after only 4 h soaking time, due to swelling of the moulding.

These and other tests led to the conclusion that the combination of a low flash point (<40° C.) blend and moderate to high aromatics content were not suitable for the new moulding compositions.

### COMPARATIVE EXAMPLE 3

The new mouldings were tested on combinations of higher flash point (total >40° C.)/low aromatic content (<1%). A solution was prepared by blending the following ingredients together in a container in the stated quantities:
60% by weight of Nappar 10 (Exxon Mobil), flash point 43° C., naphthenic/paraffinic blend;
20% by weight of aliphatic petroleum naphtha (“white spirit”, CAS No. 64742-88-7) flash point 42° C.;
20% by weight of Shellsol D60, flash point 66° C.

The blend was tested for a period of 18h, after which the body moulding was removed and inspected. It was found that the double-sided tape could be removed satisfactorily, but that there was slight damage to the moulding. The “soft plastic” moulding stretched and swelled and did not return to normal after drying. Hence, this blend is not preferred.

### EXAMPLE 1

A proportion of the aliphatic solvent was replaced with any of D-limonene, Tea Tree oil or Eucalyptus oil. A solution was prepared by blending the following ingredients together in a container in the stated quantities:
60% by weight of aliphatic petroleum naphtha (“white spirit”, CAS No. 64742-88-7) flash point 42° C.;
30% by weight of D-limonene;
10% by weight of Nappar 11, flash point 60° C., naphthenic/paraffinic blend.

The blend was tested for a period of 15 h, after which the body moulding was removed and inspected. In contrast to the previous examples, it was found that there was no damage to the “soft plastic” moulding. However, the double-sided tape could only be removed satisfactorily with the aid of extra solvents (paint thinners). Therefore, this combination is not preferred.

### EXAMPLE 2

Any of D-limonene, Tea Tree oil or Eucalyptus oil can be used in the following example. A solution was prepared by blending the following ingredients together in a container in the stated quantities:
80% by weight of aliphatic petroleum naphtha (“white spirit”, CAS No. 64742-88-7) flash point 42° C.;
15% by weight of D-limonene;
5% by weight of Nappar 11, flash point 60° C., naphthenic/paraffinic blend.

The blend was tested for a period of 15 h, after which the body moulding was removed and inspected. As in Example 1, it was found that there was no damage to the “soft plastic” moulding. Additionally, the double-sided tape did not require the aid of extra solvents (paint thinners). However, a spatula was required to remove the tape from the moulding. Whilst acceptable, this is not preferred as it has a labour time associated with the process. Therefore, this combination is not preferred.

### EXAMPLE 3

Any of D-limonene, Tea Tree oil or Eucalyptus oil can be used in the following example. A solution was prepared by blending the following ingredients together in a container in the stated quantities:
50% by weight of Nappar 11, flash point 60° C., naphthenic/paraffinic blend;
30% fatty acid methyl ester;
10% by weight of D-limonene;
5% hexylene glycol diluent (optional) 5% by weight of aliphatic petroleum naphtha (“white spirit”, CAS No. 64742-88-7) flash point 42° C.;

The blend was tested for a period of 12 h, after which the body moulding was removed and inspected. As in Examples 1 and 2, it was found that there was no damage to the “soft plastic” moulding. Additionally, the double-sided tape did not require the aid of extra solvents (paint thinners). However, a spatula was required to remove the tape from the moulding. Whilst acceptable, this is not preferred as it has an extra labour time associated with the process. Therefore, this combination is not preferred.

### EXAMPLE 4

Any of D-limonene, Tea Tree oil or Eucalyptus oil can be used in the following example. A solution was prepared by blending the following ingredients together in a container in the stated quantities:
70% by weight of Happar 11, flash point 60° C., naphthenic/paraffinic blend;
20% by weight of Shelldol D60, flash point 66° C.;
5% by weight of D-limonene;
5% fatty acid methyl ester.

The blend was tested for a period of 24 h, after which the body moulding was removed and inspected. As in Example 3, it was found that there was no damage to the “soft plastic” moulding. Additionally, the double-sided tape did not require the aid of extra solvents (paint thinners), or the aid of a spatula to remove the tape from the moulding. Whilst acceptable from an outcome and labour point of view, this is not preferred as it has an unacceptably long soaking time associated with the process. Reduced soaking times failed to achieve all of the desired objectives. Therefore, this combination is not preferred.

### EXAMPLE 5

Any of D-limonene, Tea Tree oil or Eucalyptus oil can be used in the following example. A solution was prepared by blending the following ingredients together in a container in the stated quantities:
90% by weight of Nappar 11, flash point 60° C., naphthenic/paraffinic blend;
5% by weight of Shellsol D60, flash point 66° C.;
3% by weight of D-limonene;
2% fatty acid methyl ester.

The blend was tested for a period of 16 h, after which the body moulding was removed and inspected. As in Examples 1 and 2, it was found that there was no damage to the “soft plastic” moulding. Additionally, the double-sided tape did not require the aid of extra solvents (paint thinners), or the aid of a spatula to remove the tape from the moulding. Whilst acceptable from an outcome and labour point of view, this is not preferred as it has an unacceptably long soaking time associated with the process. Therefore, this combination is not preferred.

### EXAMPLE 6

Any of D-limonene, Tea Tree oil or Eucalyptus oil can be used in the following example. A solution was prepared by blending the following ingredients together in a container in the stated quantities:
95% by weight of Nappar 11, flash point 60° C., naphthenic/paraffinic blend;
2% by weight of Shellsol D60, flash point 66° C.;
2% by weight of D-limonene;
1% by weight of aliphatic petroleum naphtha (“white spirit”, CAS No. 64742-88-7) flash point 42° C.;

The blend was tested for a period of 24h, after which the body moulding was removed and inspected. As in Examples 1 and 2, it was found that there was no damage to the “soft plastic” moulding. Additionally, as in Examples 4 and 5, the double-sided tape did not require the aid of extra solvents (paint thinners), or the aid of a spatula to remove the tape from the moulding. Whilst acceptable from an outcome and labour point of view, this is not preferred as it has an unacceptably long soaking time associated with the process. Therefore, this combination is not preferred.

### EXAMPLE 7

Any of D-limonene, Tea Tree oil or Eucalyptus oil can be used in the following example. A solution was prepared by blending the following ingredients together in a container in the stated quantities:
92% by weight of Nappar 11, flash point 60° C., naphthenic/paraffinic blend;
2% by weight of Shellsol D60, flash point 66° C.;
2% by weight of aliphatic petroleum naphtha (“white spirit”, CAS No. 64742-88-7) flash point 42° C.;
1% by weight of D-limonene;
1% fatty acid methyl ester.

The blend was tested for a period of 36 h, after which the body moulding was removed and inspected. As in Examples 1 and 2, it was found that there was no damage to the “soft plastic” moulding. Additionally, as in Examples 4-6, the double-sided tape did not require the aid of extra solvents (paint thinners), or the aid of a spatula to remove the tape from the moulding. Whilst acceptable from an outcome and labour point of view, this is not preferred as it has an unacceptably long soaking time associated with the process. Therefore, this combination is not preferred.

### EXAMPLE 8

Any of D-limonene, Tea Tree oil or Eucalyptus oil can be used in the following example. A solution was prepared by blending the following ingredients together in a container in the stated quantities:
94% by weight of Nappar 11, flash point 60° C., naphthenic/paraffinic blend;
3% by weight of aliphatic petroleum naphtha (“white spirit”, CAS No. 64742-88-7) flash point 42° C.;
2% by weight of D-limonene;
1% by weight of Shellsol D60, flash point 66° C.;
hexylene glycol diluent (optional)

The blend was tested for a period of 56 h, after which the body moulding was removed and inspected. As in Examples 1 and 2, it was found that there was no damage to the “soft plastic” moulding. Additionally, as in Examples 4-7, the double-sided tape did not require the aid of extra solvents (paint thinners), or the aid of a spatula to remove the tape from the moulding. Whilst acceptable from an outcome and labour point of view, this is not preferred as it has an unacceptably long soaking time associated with the process. Therefore, this combination is not preferred.

### EXAMPLE 9

Any of D-limonene, Tea Tree oil or Eucalyptus oil can be used in the following example. A solution was prepared by blending the following ingredients together in a container in the stated quantities:
80% by weight of Nappar 11, flash point 60° C., naphthenic/paraffinic blend;
10% by weight of Shellsol D60, flash point 66° C.;
5% by weight of D-limonene;
3% by weight of aliphatic petroleum naphtha (“white spirit”, CAS No. 64742-88-7) flash point 42° C.;
2% fatty acid methyl ester;
hexylene glycol diluent optional.

The blend was tested for a period of 12 h, after which the body moulding was removed and inspected. As in Examples 1 and 2, it was found that there was no damage to the “soft plastic” moulding. Additionally, as in Examples 4-6, the double-sided tape did not require the aid of extra solvents (paint thinners), or the aid of a spatula to remove the tape from the moulding.

Most importantly, the soaking time now corresponded to the time between placing the moulding in the trough last thing at night, and removing it first thing in the morning for disassembly. This combination is preferred from the point of view of not causing damage to the mould, minimizing labour and making the most efficient use of work-time.

The current invention is successful at removing the backing tape from current generation mouldings (thermoplastic olefin (elastomer), thermoplastic rubber-modified, high-density polyethylene), as well as those with aluminum backing (such as on the Ford Mustang).

Throughout this specification and the claims, the words “comprise”, “comprises” and “comprising” are used in a non-exclusive sense, except where the context requires otherwise.

It will be clearly understood that, although a number of prior art publications are referred to herein, this reference does not constitute an admission that any of these documents forms part of the common general knowledge in the art, in Australia or in any other country.

1-10. (canceled)

11. A method of removing adhesive tape from a body moulding of a motor vehicle, boat, caravan or like conveyance, said method consisting essentially of the steps of:
1) applying a terpene to said body moulding;
2) maintaining contact between the terpene and said body moulding for at least 3 hours; and 3) removing said adhesive tape from said body moulding.

12. A method according to claim 11 wherein contact is maintained by immersion of said body moulding.

13. A method according to claim 11 wherein the terpene is applied as a solution for removing adhesive tape from a body moulding of a motor vehicle, boat, caravan or like conveyance, for rejuvenating said body moulding, or for both, said solution consisting essentially of: 1-99% by weight of a terpene; and 1-99% by weight of a diluent for said terpene.

14. A method of repairing a motor vehicle, boat, caravan or like conveyance, said method consisting essentially of the steps of:
1) removing an intact body moulding from a damaged portion of said motor vehicle, boat, caravan or like conveyance, said body moulding having been previously secured thereto with adhesive tape;
2) applying a terpene to said body moulding and maintaining contact between the terpene and said body moulding for a at least 3 hours;
3) removing said adhesive tape from said body moulding; and
4) replacing said body moulding upon the now-repaired motor vehicle, boat, caravan or like conveyance.

15. A method of rejuvenating a body moulding of a motor vehicle, boat, caravan or like conveyance, said method consisting essentially of the steps of:
1) applying a terpene to said body moulding; and
2) maintaining contact between the terpene and said body moulding for at least 3 hours.

16. A method according to claim 15 wherein contact is maintained by immersion of said body moulding.

17. A method according to claim 16 wherein the terpene is applied as a solution for removing adhesive tape from a body moulding of a motor vehicle, boat, caravan or like conveyance, for rejuvenating said body moulding, or for both, said solution consisting essentially of: 1-99% by weight of a terpene; and 1-99% by weight of a diluent for said terpene.
